(19) United States
(12) Patent Application Publication
(10) Pub. No.: US 2026/0127685 A1
(43) Pub. Date: May 7, 2026

(54) SYSTEM AND METHOD OF INTEGRATED WATER AND FERTILIZER PLANTING AND INDUSTRIAL COLLABORATION FOR TERRACED FIELD IN ECOLOGICALLY FRAGILE AREA

(71) Applicants: Henan Water Environment Survey and Design Co., Ltd, Sanmenxia (CN); Yellow River Institute of Hydraulic Research, YRCC, Zhengzhou (CN); Henan Shangyu Electromechanical Equipment Manufacturing Co., Ltd, Xinyang (CN); Yellow River Conservancy Technical College, Kaifeng (CN)

(72) Inventors: Wenyi Yao, Zhengzhou (CN); Wenmin Zhang, Zhengzhou (CN); Zhenzhou Shen, Zhengzhou (CN); Zongrui Zhao, Zhengzhou (CN); Shuangjiang Li, Zhengzhou (CN); Zuolong Hu, Zhengzhou (CN); Feng Feng, Zhengzhou (CN); Wenxian Liu, Zhengzhou (CN); Peiqing Xiao, Zhengzhou (CN); Yan Wu, Zhengzhou (CN); Mian Li, Zhengzhou (CN); Binbin Li, Zhengzhou (CN); Hao Hu, Zhengzhou (CN); Fengdong Wu, Zhengzhou (CN); Tong Duan, Zhengzhou (CN); Pan Zhang, Zhengzhou (CN); Peng Jiao, Zhengzhou (CN); Haibin Zhao, Zhengzhou (CN); Fang Zhang, Zhengzhou (CN); Jiayu Chen, Zhengzhou (CN); Gaogong Wei, Zhengzhou (CN); Yuangtan Zhong, Zhengzhou (CN); Yanfei Zuo, Zhengzhou (CN)

(21) Appl. No.: 19/036,222

(22) Filed: Jan. 24, 2025

(30) Foreign Application Priority Data
Nov. 7, 2024 (CN) 2024115789343

(51) Int. Cl. G06Q 50/02; A01C 21/00; A01G 25/16; C05G 1/00; G06Q 10/0631

(52) U.S. Cl. CPC G06Q 50/02; A01C 21/005; A01G 25/16; C05G 1/00; G06Q 10/06315

(57) ABSTRACT

A system of integrated water and fertilizer planting and industrial collaboration for a terraced field in an ecologically fragile area includes a hardware part, a software part, a water balance and osmosis model, a water and fertilizer optimization and adjustment model, and an industry collaboration model. The hardware part includes a terraced field intelligent irrigation equipment, soil moisture sensors, a meteorological station, a fertilizer application device, an underground water storage system, and a solar power supply. The system introduces the water balance and osmosis model to effectively manage water resources in terraced field. By integrating data from the soil sensors and meteorological station, it automatically optimizes the methods of irrigation and fertilization, preventing water waste and soil erosion. The water and fertilizer optimization and adjustment model can dynamically adjust the application of nitrogen, potassium, and phosphorus fertilizers based on real-time environmental data and crop requirements.

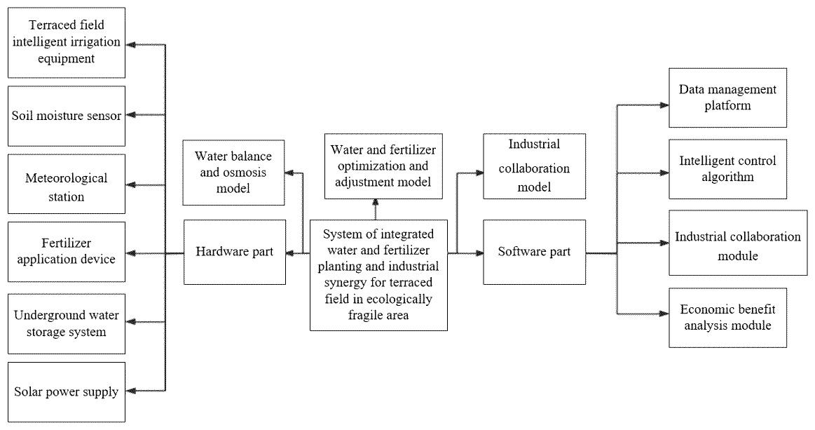

### TECHNICAL FIELD

The disclosure relates to the technical field of integrated water and fertilizer planting and industrial collaboration, and particularly to a system and a method of integrated water and fertilizer planting and industrial collaboration for a terraced field in an ecologically fragile area.

### BACKGROUND

Ecologically fragile areas mainly refer to areas with low environmental carrying capacity and ecosystems that are easily disturbed and damaged by external factors, such as areas with poisonous sandstone and wind-sand regions. Due to harsh natural conditions, these areas suffer from prominent problems like soil erosion and land desertification. Traditional agricultural production methods often fail to maintain stable yields. Therefore, for these areas, a system of terraced field integrated water and fertilizer planting and industrial collaboration in ecologically fragile areas is provided, which aims to optimize agricultural management measures and improve a utilization rate of resources as well as a capacity for ecological recovery.

A main content of the system includes: in the ecologically fragile areas, land is transformed through a construction of terraces, which can effectively reduce soil erosion and increase a water retention capacity of soil. In these areas, due to a shortage of water resources and poor soil fertility, it is essential to maximize an efficiency of resource utilization to promote crop growth. Based on characteristics of the ecologically fragile areas, suitable crop varieties and planting patterns are selected. By promoting planting patterns suitable for the ecologically fragile areas and combining local resource endowments, characteristic agricultural industries are developed, such as a cultivation of traditional Chinese medicinal herbs and ecological tourism, to promote a sustainable development of regional economy.

However, due to severe natural conditions in the ecologically fragile areas, the existing integrated water and fertilizer technology still fails to fully improve the efficiency of resource utilization. How to maximize the conservation and efficient use of water resources and enhance soil quality is the primary problem that urgently needs to be solved. Although a mode of planting and industrial collaboration has been proposed, the interconnectivity between various industries is insufficient, and an effective industrial chain and economic benefits have not been formed. Therefore, how to effectively plan and implement industrial collaboration and enhance an integration of ecological and economic benefits is another key problem.

### SUMMARY

To solve the above technical problems, embodiments of the disclosure provide a system and a method of integrated water and fertilizer planting and industrial collaboration for a terraced field in an ecologically fragile area, which address the problems of how to maximize a conservation and efficient use of water resources and improve soil quality, and how to effectively plan and implement industrial collaboration to enhance an integration of ecological and economic benefits.

To achieve above purposes, a system of integrated water and fertilizer planting and industrial collaboration for a terraced field in an ecologically fragile area is provided. The system includes a hardware part, a software part, a water balance and osmosis model, a water and fertilizer optimization and adjustment model, and an industry collaboration model. The hardware part includes terraced field intelligent irrigation equipment, soil moisture sensors, a meteorological station, fertilizer application devices, an underground water storage system, and a solar power supply. The terraced field intelligent irrigation equipment is configured to monitor humidity, temperature, and climatic conditions of the terraced field in real time through the soil moisture sensors and the meteorological station, and combine topographical features and crop requirements to achieve precise water and fertilizer management. The software part includes a data management platform, an intelligent control algorithm, an industrial collaboration module, and an economic benefit analysis module, and the software part is configured to integrate ecological and economic benefits. An optimized integrated water and fertilizer solution for respective regions of the terraced field is provided through data analysis, thereby achieving precise control of water resources of the terraced field, and coordinating an optimal regional industry layout.

In an embodiment, the data management platform includes an agricultural science big data platform and a smart agriculture big data platform, the agricultural science big data platform is configured to manage and analyze data in an agricultural field, and integrate sensor data and meteorological data to provide decision support. The smart agriculture big data platform is configured to integrate agricultural production data to support agricultural decision-making, covering aspects such as land management, crop management, and irrigation and fertilization. The intelligent control algorithm includes a Chinese Academy of

Sciences (CAS) agricultural intelligent control system and a smart farmland management system. The CAS agricultural intelligent control system is configured to provide agricultural production management based on big data and AI technologies, with applications in precision irrigation, precision fertilization, and other fields. The smart farmland management system is configured to automate farmland management through the IoT and intelligent algorithms, including functions such as irrigation, fertilization, and temperature control. The industrial collaboration module includes an agricultural industry chain collaboration platform and an agricultural product supply chain collaboration platform. The agricultural industry chain collaboration platform is configured to promote collaboration among various links in the agricultural supply chain and enhances efficiency through information sharing and resource integration. The agricultural product supply chain collaboration platform is configured to connect farmers, process enterprises, retailers, and consumers, this platform facilitates efficient collaboration in the agricultural industry. The economic benefit analysis module includes a farm economic benefit analysis system and a smart agriculture economic analysis platform. The farm economic benefit analysis system is configured to evaluate the impact of different agricultural management practices on economic benefits, helping farmers make data-driven decisions. The smart agriculture economic analysis platform is configured to provides economic benefit analysis for agricultural production, integrating climate, land, and crop data to optimize resource allocation.

In an embodiment, each of the data management platform, the intelligent control algorithm, the industrial collaboration module, and the economic benefit analysis module is embedded by software stored in at-least one memory and executable by at least one processor.

The water balance and osmosis model is configured to manage water resources of the terraced field precisely to thereby avoid soil erosion and achieve efficient utilization of the water resources as per a composite formula as follows:

$$W ( t ) = {W}_{0} + P - {ET}_{c} - ( {R}_{s} + {R}_{g} ) - D$$

where W(t) represents current soil moisture, W₀ represents initial soil moisture, P represents precipitation, ET_{c} represents transpiration of crops, Rₛ represents a surface runoff, R_{g} represents a subsurface runoff, and D represents a deep percolation. The system is configured to adjust an irrigation method based on the water balance and osmosis model in combination with slopes and soil characteristics of different regions of the terraced field to reduce waste of water resources.

The water and fertilizer optimization and adjustment model is configured to achieve refined water and fertilizer management for the different regions of the terraced field as per an optimization formula as follows:

$$F ( t ) = {\int }_{{t}_{0}}^{{t}_{1}} [ N ( t ) \cdot {f}_{1} ( {S}_{t} , {P}_{t} ) + K ( t ) \cdot {f}_{2} ( T , H ) + P ( t ) \cdot {f}_{3} ( W , A ) ] dt$$

where F(t) represents a total application amount of fertilizers; N(t), K(t), P(t) represent time functions of nitrogen fertilizer, potassium fertilizer, and phosphorus fertilizer, respectively; f₁(Sₜ, Pₜ) represents a function of a nitrogen fertilizer application dynamically adjusted according to soil moisture Sₜ and precipitation Pₜ; f₂(T, H) represents a function of a potassium fertilizer application adjusted according to temperature T and humidity H; f₃(W, A) represents a function of a phosphorus fertilizer application adjusted according to a crop growth cycle W and an area A of each of the regions of the terraced field. The system is, based on the water and fertilizer optimization and adjustment model, capable of dynamically adjusting supplies of water and fertilizer based on real-time environmental data and crop requirements, thereby ensuring efficient resource utilization.

The industrial collaboration model is configured to maximize an integration of ecological and economic benefits and introduce a multi-objective optimization model to collaborate a regional industrial planning as per a formula as follows:

$$E ( t ) = max ( {\int }_{{t}_{0}}^{{t}_{1}} [ {α}_{1} \cdot {Y}_{c} ( t ) - {β}_{1} \cdot {C}_{c} ( t ) ] dt ) + max ( {\int }_{{t}_{0}}^{{t}_{1}} [ {α}_{2} \cdot {Y}_{f} ( t ) - {β}_{2} \cdot {C}_{f} ( t ) ] dt )$$

where E(t) represents an overall economic benefit; Y_{c}(t) and Y_{f}(t) represent an output quantity of crops and an output quantity of fruits, respectively; C_{c}(t) and C_{f}(t) represent a planting cost of crops and a planting cost of fruits, respectively; α₁ and α₂ represent weight coefficients of the output quantity of crops and the output quantity of fruits, respectively; β₁ and β₂ represent weight coefficients of the planting cost of crops and the planting cost of fruits, respectively. The system is, based on the industrial collaboration model, capable of dynamically optimizing multiple industries including agriculture and forestry according to soil characteristics and water resources of the different regions of the terraced field, thereby enhancing the overall economic benefit of the terraced field.

In an embodiment, the function f₁(Sₜ, Pₜ) is configured to dynamically regulate an application amount of the nitrogen fertilizer based on changes in the soil moisture Sₜ and the precipitation Pₜ, to prevent a loss of nitrogen fertilizer or an insufficient supply of nitrogen fertilizer, and the function f₁(Sₜ, Pₜ) is expressed as follows:

$${f}_{1} ( {S}_{t} , {P}_{t} ) = {γ}_{1} \cdot ( \frac{{S}_{t}}{{S}_{opt}} ) \cdot exp ( - {δ}_{1} \cdot {P}_{t} )$$

where Sₒₚₜ represents an optimal soil moisture; γ₁ represents an application coefficient of nitrogen fertilizer; and δ₁ represents a coefficient of controlling an effect of the precipitation on the application amount of the nitrogen fertilizer.

The potassium fertilizer application is closely related to the temperature T and the humidity H, especially an absorption rate of crops to the potassium fertilizer changes under different temperature conditions, and the function f₂(T, H) is expressed as follows:

$${f}_{2} ( T , H ) = {γ}_{2} \cdot \frac{T}{{T}_{opt}} \cdot exp ( - {δ}_{2} \cdot \vert H - {H}_{opt} \vert )$$

where Tₒₚₜ represents an optimal growth temperature, Hₒₚₜ represents optimal humidity, γ₂ represents a coefficient of the potassium fertilizer application, and δ₂ represents a regulation coefficient of the temperature T and the humidity H on the potassium fertilizer application.

The phosphorus fertilizer application is closely related to crop growth stages, the phosphorus fertilizer application varies at different crop growth stages in the crop growth cycle W, and areas A of the regions of the terraced field are taken in consideration to ensure that each unit of area receives sufficient nutrients, and the function f₃(W, A) is expressed as follows:

$${f}_{3} ( W , A ) = {α}_{3} \cdot \frac{W}{{W}_{max}} \cdot A$$

where Wₘₐₓ represents a maximum crop growth cycle; and α₃ represents an application coefficient of phosphorus fertilizer.

In an embodiment, the soil moisture sensors include a potential of hydrogen (pH) sensor and a nutrient sensor, the pH sensor and the nutrient sensor are configured to monitor a pH value, a nutrient content, and moisture of soil in the terraced field in real time. The meteorological station is configured to monitor a wind speed, the precipitation, the temperature, and the humidity in real time, and transmit data of the wind speed, the precipitation, the temperature, and the humidity through the data management platform for adjusting irrigation and fertilization methods. The underground water storage system includes a water reservoir and a rainwater collection system, and is configured to collect and store rainwater to thereby reduce waste of water resources and provide supplementary water sources for irrigation. The water and fertilizer optimization and regulation model is configured to combine the crop growth cycle and changes in soil fertility.

A method of integrated water and fertilizer planting and industrial collaboration for a terraced field in an ecologically fragile area includes steps as follows:
step a, arranging a terraced field intelligent irrigation equipment, soil moisture sensors, a meteorological station, fertilizer application devices, an underground water storage system, and a solar power supply in the terraced field in the ecologically fragile area, and monitoring humidity, temperature, and climatic conditions of the terraced field in real time;
step b, dynamically analyzing, based on data collected by the soil moisture sensors and the meteorological station, variables of soil moisture, temperature, precipitation and a wind speed in each of regions of the terraced field, and generating optimized water and fertilizer management methods for the respective regions of the terraced field through a data management platform;
step c, using a water balance and osmosis model to optimize scheduling of water resources, thereby preventing soil erosion and achieving an efficient utilization of water resources;
step d, adjusting irrigation methods in consideration of slopes, soil structures, and vegetation characteristics of the regions of the terraced field to ensure an optimal allocation of water resources;
step e, using a water and fertilizer optimization and adjustment model to determine application amounts of nitrogen fertilizer, potassium fertilizer and phosphorus fertilizer, and dynamically adjusting supplies of water and fertilizer according to factors including the soil moisture, the precipitation, the temperature, the humidity, crop growth cycles, and areas of the respective regions;
step f, dynamically monitoring a nutrient content and a pH value of soil, and optimizing, in combination with the crop growth cycles, fertilization methods to prevent nutrient loss and improve soil quality;
step g, inputting real-time data of supplies of water and fertilizer and crop growth requirements into an intelligent control algorithm to automatically adjust the irrigation methods and application amounts of fertilizers, ensuring efficient resource utilization;
step h, monitoring environmental conditions in real time through the meteorological station and adjusting system operating parameters, to avoid unnecessary waste of water and fertilizer;
step i, using an underground water storage system to collect and store rainwater for irrigation, thereby minimizing waste of water resources and improving water resource utilization of the terraced field;
step j, using an industrial collaboration model to optimize a regional industrial layout and thereby enhance an overall economic benefit, and dynamically optimizing industries including agriculture and forestry according to soil and water resources of the respective regions in the terraced field;
step k, analyzing input-output ratios of the respective regions, and automatically planning optimal crop planting types and areas to achieve ecological and industrial collocation in the respective regions of the terraced field; and
step l, generating a report through an economic benefit analysis module to assess efficiency of water resource utilization, improvement of soil quality, and a change of crop yield, and making, in combination with ecological protection and industrial benefits, dynamic adjustments on supplies of water and fertilizer.

In an embodiment, the method further incudes steps as follows:
setting alarm thresholds, through the system, based on the environmental conditions of the report; in response to a value of one of the environmental conditions exceeding the alarm thresholds, an alarm function being automatically triggered.

In an embodiment, the application amount of nitrogen fertilizer is dynamically adjusted according to the soil moisture and the precipitation, in combination with the crop growth requirements, to thereby prevent loss or insufficient supply of nitrogen fertilizer.

In an embodiment, the intelligent control algorithm optimizes water and fertilizer management of the terraced field through machine learning, and dynamically adjust the supplies of water and fertilizer based on historical data, meteorological forecasts, and the crop growth cycles.

In an embodiment, the industrial collaboration model analyzes ecological conditions, crop planting types, and water resource utilization in the respective regions of the terraced field and optimizes a regional industrial planning, thereby achieving a coordinated development of agriculture, forestry, and animal husbandry.

In an embodiment, the economic benefit analysis module compares crop yields and the input-output ratios of the respective regions of the terraced field to generate an optimized industrial layout, and evaluates utilization efficiency of the water resources and the fertilizers.

The beneficial effects of the disclosure are as follows.

The disclosure introduces a water balance and osmosis model to effectively manage water resources in the terraced field. By integrating data from the soil sensors and the meteorological station, it automatically optimizes the irrigation method and the fertilization method, preventing waste of water resources and soil erosion. The water and fertilizer optimization adjustment model can dynamically adjust the applications of nitrogen, potassium, and phosphorus fertilizers based on real-time environmental data and crop requirements, ensuring that crops receive the necessary nutrients, improving soil fertility, and thereby increasing crop yields.

Through the industrial collaboration model, the system can dynamically optimize the industry layout including agriculture and forestry, maximizing the integration of ecological and economic benefits. The system analyzes the soil, the water resources, and the climatic conditions of the respective regions in the terraced field, automatically planning the planting types and planting areas of crops, ensuring the collaborated development of different industries. This enhances the overall economic benefit in the respective regions, especially in ecologically fragile areas, providing technical support for sustainable development.

### BRIEF DESCRIPTION OF DRAWING

The drawing illustrates a schematic structural diagram of the disclosure.

### DETAILED DESCRIPTION OF EMBODIMENTS

A clear and complete description of the technical solutions in embodiments of the disclosure is provided. Apparently, the described embodiments are only some of the embodiments of the disclosure, not all of them. Based on the described embodiments in the disclosure, all other embodiments obtained by those skilled in the art without making any inventive effort are within the scope of protection of the disclosure.

As shown in the drawing, a system of integrated water and fertilizer planting and industrial collaboration for a terraced field in an ecologically fragile area is provided. The system includes a hardware part, a software part, a water balance and osmosis model, a water and fertilizer optimization and adjustment model, and an industry collaboration model. The hardware part includes terraced field intelligent irrigation equipment, soil moisture sensors, a meteorological station, fertilizer application devices, an underground water storage system, and a solar power supply. The terraced field intelligent irrigation equipment is configured to monitor humidity, temperature, and climatic conditions of the terraced field in real time through the soil moisture sensors and the meteorological station, and combine topographical features and crop requirements to achieve precise water and fertilizer management. The software part includes a data management platform, an intelligent control algorithm, an industrial collaboration module, and an economic benefit analysis module, and the software part is configured to integrate ecological and economic benefits. An optimized integrated water and fertilizer solution for respective regions of the terraced field is provided through data analysis, thereby achieving precise control of water resources of the terraced field, and coordinating an optimal regional industry layout.

The water balance and osmosis model is configured to manage water resources of the terraced field precisely to thereby avoid soil erosion and achieve efficient utilization of the water resources as per a composite formula as follows:

$$W ( t ) = {W}_{0} + P - E {T}_{c} - ( {R}_{s} + {R}_{g} ) - D$$

where W(t) represents current soil moisture, W₀ represents initial soil moisture, P represents precipitation, ET_{c} represents transpiration of crops, Rₛ represents a surface runoff, R_{g} represents a subsurface runoff, and D represents a deep percolation. The system is configured to adjust an irrigation method based on the water balance and osmosis model in combination with slopes and soil characteristics of different regions of the terraced field to reduce waste of water resources.

The water and fertilizer optimization and adjustment model is configured to achieve refined water and fertilizer management for the different regions of the terraced field as per an optimization formula as follows:

$$F ( t ) = {\int }_{{t}_{0}}^{{t}_{1}} [ N ( t ) \cdot {f}_{1} ( {S}_{t} , {P}_{t} ) + K ( t ) \cdot {f}_{2} ( T , H ) + P ( t ) \cdot {f}_{3} ( W , A ) ] dt$$

where F(t) represents a total application amount of fertilizers; N(t), K(t), P(t) represent time functions of nitrogen fertilizer, potassium fertilizer, and phosphorus fertilizer, respectively; f₁(Sₜ, Pₜ) represents a function of a nitrogen fertilizer application dynamically adjusted according to soil moisture Sₜ and precipitation Pₜ; f₂(T, H) represents a function of a potassium fertilizer application adjusted according to temperature T and humidity H; f₃(W, A) represents a function of a phosphorus fertilizer application adjusted according to a crop growth cycle W and an area A of each of the regions of the terraced field. The system is, based on the water and fertilizer optimization and adjustment model, capable of dynamically adjusting supplies of water and fertilizer based on real-time environmental data and crop requirements, thereby ensuring efficient resource utilization.

The industrial collaboration model is configured to maximize an integration of ecological and economic benefits and introduce a multi-objective optimization model to collaborate a regional industrial planning as per a formula as follows:

$$E ( t ) = max ( {\int }_{{t}_{0}}^{{t}_{1}} [ {α}_{1} \cdot {Y}_{c} ( t ) - {β}_{1} \cdot {C}_{c} ( t ) ] dt ) + max ( {\int }_{{t}_{0}}^{{t}_{1}} [ {α}_{2} \cdot {Y}_{f} ( t ) - {β}_{2} \cdot {C}_{f} ( t ) ] d t )$$

where E(t) represents an overall economic benefit; Y_{c}(t) and Y_{f}(t) represent an output quantity of crops and an output quantity of fruits, respectively; C_{c}(t) and C_{f}(t) represent a planting cost of crops and a planting cost of fruits, respectively; α₁ and α₂ represent weight coefficients of the output quantity of crops and the output quantity of fruits, respectively; β₁ and β₂ represent weight coefficients of the planting cost of crops and the planting cost of fruits, respectively. The system is, based on the industrial collaboration model, capable of dynamically optimizing multiple industries including agriculture and forestry according to soil characteristics and water resources of the different regions of the terraced field, thereby enhancing the overall economic benefit of the terraced field.

In an embodiment, the function f₁(Sₜ, Pₜ) is configured to dynamically regulate an application amount of the nitrogen fertilizer based on changes in the soil moisture Sₜ and the precipitation Pₜ, to prevent a loss of nitrogen fertilizer or an insufficient supply of nitrogen fertilizer, and the function f₁(Sₜ, Pₜ) is expressed as follows:

$${f}_{1} ( {S}_{t} , {P}_{t} ) = {γ}_{1} \cdot ( \frac{{S}_{t}}{{S}_{opt}} ) \cdot exp ( - {δ}_{1} \cdot {P}_{t} )$$

where Sₒₚₜ represents an optimal soil moisture; γ₁ represents an application coefficient of nitrogen fertilizer; and δ₁ represents a coefficient of controlling an effect of the precipitation on the application amount of the nitrogen fertilizer.

The potassium fertilizer application is closely related to the temperature T and the humidity H, especially an absorption rate of crops to the potassium fertilizer changes under different temperature conditions, and the function f₂(T, H) is expressed as follows:

$${f}_{2} ( T , H ) = {γ}_{2} . \frac{T}{{T}_{opt}} \cdot exp ( - {δ}_{2} \cdot \vert H - {H}_{opt} \vert )$$

where Tₒₚₜ represents an optimal growth temperature, Hₒₚₜ represents optimal humidity, γ₂ represents a coefficient of the potassium fertilizer application, and δ₂ represents a regulation coefficient of the temperature T and the humidity H on the potassium fertilizer application.

The phosphorus fertilizer application is closely related to crop growth stages, the phosphorus fertilizer application varies at different crop growth stages in the crop growth cycle W, and areas A of the regions of the terraced field are taken in consideration to ensure that each unit of area receives sufficient nutrients, and the function f₃(W, A) is expressed as follows:

$${f}_{3} ( W , A ) = {α}_{3} \cdot \frac{W}{{W}_{max}} \cdot A$$

where Wₘₐₓ represents a maximum crop growth cycle; and α₃ represents an application coefficient of phosphorus fertilizer.

In an embodiment, the soil moisture sensors include a pH sensor and a nutrient sensor, the pH sensor and the nutrient sensor are configured to monitor a pH value, a nutrient content, and moisture of soil in the terraced field in real time. The meteorological station is configured to monitor a wind speed, the precipitation, the temperature, and the humidity in real time, and transmit data of the wind speed, the precipitation, the temperature, and the humidity through the data management platform for adjusting irrigation and fertilization methods. The underground water storage system includes a water reservoir and a rainwater collection system, and is configured to collect and store rainwater to thereby reduce waste of water resources and provide supplementary water sources for irrigation. The water and fertilizer optimization and regulation model is configured to combine the crop growth cycle and changes in soil fertility.

A method of integrated water and fertilizer planting and industrial collaboration for a terraced field in an ecologically fragile area includes steps as follows.

step a, a terraced field intelligent irrigation equipment, soil moisture sensors, a meteorological station, fertilizer application devices, an underground water storage system, and a solar power supply are arranged in the terraced field in the ecologically fragile area, and humidity, temperature, and climatic conditions of the terraced field are monitored in real time. The intelligent control algorithm optimizes water and fertilizer management of the terraced field through machine learning, and dynamically adjust the supplies of water and fertilizer based on historical data, meteorological forecasts, and the crop growth cycles.
step b, variables of soil moisture, temperature, precipitation and a wind speed in each of regions of the terraced field are dynamically analyzed based on data collected by the soil moisture sensors and the meteorological station, and optimized water and fertilizer management methods for the respective regions of the terraced field are generated through a data management platform.
step c, a water balance and osmosis model is used to optimize scheduling of water resources, thereby preventing soil erosion and achieving an efficient utilization of water resources.
step d, irrigation methods are adjusted in consideration of slopes, soil structures, and vegetation characteristics of the regions of the terraced field to ensure an optimal allocation of water resources.
step e, a water and fertilizer optimization and adjustment model is used to determine application amounts of nitrogen fertilizer, potassium fertilizer and phosphorus fertilizer, and supplies of water and fertilizer are dynamically adjusted according to factors including the soil moisture, the precipitation, the temperature, the humidity, crop growth cycles, and areas of the respective regions. The application amount of nitrogen fertilizer is dynamically adjusted according to the soil moisture and the precipitation, in combination with the crop growth requirements, to thereby prevent loss or insufficient supply of nitrogen fertilizer.
step f, a nutrient content and a pH value of soil are dynamically monitored, and fertilization methods are optimized in combination with the crop growth cycles to prevent nutrient loss and improve soil quality.
step g, real-time data of supplies of water and fertilizer and crop growth requirements are input into an intelligent control algorithm to automatically adjust the irrigation methods and application amounts of fertilizers, thereby ensuring efficient resource utilization.
step h, environmental conditions in real time are monitored through the meteorological station and system operating parameters are adjusted, to avoid unnecessary waste of water and fertilizer.
step i, an underground water storage system is used to collect and store rainwater for irrigation, thereby minimizing waste of water resources and improving water resource utilization of the terraced field.
step j, an industrial collaboration model is used to optimize a regional industrial layout and thereby enhance an overall economic benefit, and industries including agriculture and forestry are dynamically optimized according to soil and water resources of the respective regions in the terraced field. The industrial collaboration model analyzes ecological conditions, crop planting types, and water resource utilization in the respective regions of the terraced field and optimizes a regional industrial planning, thereby achieving a coordinated development of agriculture, forestry, and animal husbandry.
step k, input-output ratios of the respective regions are analyzed, and optimal crop planting types and areas are automatically planned to achieve ecological and industrial collocation in the respective regions of the terraced field.
l. a report is generated through an economic benefit analysis module to assess efficiency of water resource utilization, improvement of soil quality, and a change of crop yield, and dynamic adjustments are made on supplies of water and fertilizer in combination with ecological protection and industrial benefits. The economic benefit analysis module compares crop yields and the input-output ratios of the respective regions of the terraced field to generate an optimized industrial layout, and evaluates utilization efficiency of the water resources and the fertilizers.

Although the embodiment of the disclosure have been shown and described, it is understood by those skilled in the art that various changes, modifications, substitutions, and variations can be made to the embodiment without departing from the principles and spirit of the disclosure. The scope of the disclosure is defined by the appended claims and their equivalents.

What is claimed is:

1. A system of integrated water and fertilizer planting and industrial collaboration for a terraced field in an ecologically fragile area, comprising:
a hardware part, a software part, a water balance and osmosis model, a water and fertilizer optimization and adjustment model, and an industrial collaboration model;
wherein the hardware part comprises terraced field irrigation equipment, soil moisture sensors, a meteorological station, fertilizer application devices, an underground water storage system, and a solar power supply; the terraced field irrigation equipment is configured to monitor humidity, temperature, and climatic conditions of the terraced field in real time through the soil moisture sensors and the meteorological station, and combine topographical features and crop requirements to achieve water and fertilizer management;
wherein the software part comprises a data management platform, an control algorithm, an industrial collaboration module, and an economic benefit analysis module, and the software part is configured to integrate ecological and economic benefits;
wherein the water balance and osmosis model is configured to manage water resources of the terraced field to thereby avoid soil erosion and achieve efficient utilization of the water resources as per a composite formula as follows:
$$W ( t ) = {W}_{0} + P - {ET}_{c} - ( {R}_{s} + {R}_{g} ) - D$$
where W(t) represents current soil moisture, W₀ represents initial soil moisture, P represents precipitation, ET_{c} represents transpiration of crops, Rₛ represents a surface runoff, R_{g} represents a subsurface runoff, and D represents a deep percolation; the system is configured to adjust an irrigation method based on the water balance and osmosis model in combination with slopes and soil characteristics of different regions of the terraced field to reduce waste of water resources;
wherein the water and fertilizer optimization and adjustment model is configured to achieve refined water and fertilizer management for the different regions of the terraced field as per an optimization formula as follows:
$$F ( t ) = {\int }_{{t}_{0}}^{{t}_{1}} [ N ( t ) \cdot {f}_{1} ( {S}_{t} , {P}_{t} ) + K ( t ) \cdot {f}_{2} ( T , H ) + P ( t ) \cdot {f}_{3} ( W , A ) ] dt$$
where F(t) represents a total application amount of fertilizers; N(t), K(t), P(t) represent time functions of nitrogen fertilizer, potassium fertilizer, and phosphorus fertilizer, respectively; f₁(Sₜ, Pₜ) represents a function of a nitrogen fertilizer application dynamically adjusted according to soil moisture Sₜ and precipitation Pₜ; f₂(T, H) represents a function of a potassium fertilizer application adjusted according to temperature T and humidity H; f₃(W, A) represents a function of a phosphorus fertilizer application adjusted according to a crop growth cycle W and an area A of each of the regions of the terraced field; wherein the system is, based on the water and fertilizer optimization and adjustment model, capable of dynamically adjusting supplies of water and fertilizer based on real-time environmental data and crop requirements, thereby ensuring efficient resource utilization;
wherein the industrial collaboration model is configured to maximize an integration of ecological and economic benefits and introduce a multi-objective optimization model to collaborate a regional industrial planning as per a formula as follows:
$$E ( t ) = max ( {\int }_{{t}_{0}}^{{t}_{1}} [ {α}_{1} \cdot {Y}_{c} ( t ) - {β}_{1} \cdot {C}_{c} ( t ) ] dt ) + max ( {\int }_{{t}_{0}}^{{t}_{1}} [ {α}_{2} \cdot {Y}_{f} ( t ) - {β}_{2} \cdot {C}_{f} ( t ) ] d t )$$
where E(t) represents an overall economic benefit; Y_{c}(t) and Y_{f}(t) represent an output quantity of crops and an output quantity of fruits, respectively; C_{c}(t) and C_{f}(t) represent a planting cost of crops and a planting cost of fruits, respectively; α₁ and α₂ represent weight coefficients of the output quantity of crops and the output quantity of fruits, respectively; β₁ and β₂ represent weight coefficients of the planting cost of crops and the planting cost of fruits, respectively; wherein the system is, based on the industrial collaboration model, capable of dynamically optimizing multiple industries including agriculture and forestry according to soil characteristics and water resources of the different regions of the terraced field, thereby enhancing the overall economic benefit of the terraced field.

2. The system as claimed in claim 1, wherein the function f₁(Sₜ, Pₜ) is configured to dynamically regulate an application amount of the nitrogen fertilizer based on changes in the soil moisture Sₜ and the precipitation Pₜ, to prevent a loss of nitrogen fertilizer or an insufficient supply of nitrogen fertilizer, and the function f₁(Sₜ, Pₜ) is expressed as follows:
$${f}_{1} ( {S}_{t} , {P}_{t} ) = {γ}_{1} \cdot ( \frac{{S}_{t}}{{S}_{opt}} ) \cdot exp ( - {δ}_{1} \cdot {P}_{t} )$$
where Sₒₚₜ represents an optimal soil moisture; γ₁ represents an application coefficient of nitrogen fertilizer; and δ₁ represents a coefficient of controlling an effect of the precipitation on the application amount of the nitrogen fertilizer;
wherein the potassium fertilizer application is closely related to the temperature T and the humidity H, especially an absorption rate of crops to the potassium fertilizer changes under different temperature conditions, and the function f₂(T, H) is expressed as follows:
$${f}_{2} ( T , H ) = {γ}_{2} . \frac{T}{{T}_{opt}} \cdot exp ( - {δ}_{2} \cdot \vert H - {H}_{opt} \vert )$$
where Tₒₚₜ represents an optimal growth temperature, Hₒₚₜ represents optimal humidity, γ₂ represents a coefficient of the potassium fertilizer application, and 82 represents a regulation coefficient of the temperature T and the humidity H on the potassium fertilizer application;
wherein the phosphorus fertilizer application is closely related to crop growth stages, the phosphorus fertilizer application varies at different crop growth stages in the crop growth cycle W, and areas A of the regions of the terraced field are taken in consideration to ensure that each unit of area receives sufficient nutrients, and the function f₃(W, A) is expressed as follows:
$${f}_{3} ( W , A ) = {α}_{3} \cdot \frac{W}{{W}_{max}} \cdot A$$
where Wₘₐₓ represents a maximum crop growth cycle, and α₃ represents an application coefficient of phosphorus fertilizer.

3. The system as claimed in claim 1, wherein the soil moisture sensors comprise a potential of hydrogen (pH) sensor and a nutrient sensor, the pH sensor and the nutrient sensor are configured to monitor a pH value, a nutrient content, and moisture of soil in the terraced field in real time;
the meteorological station is configured to monitor a wind speed, the precipitation, the temperature, and the humidity in real time, and transmit data of the wind speed, the precipitation, the temperature, and the humidity through the data management platform for adjusting irrigation and fertilization methods;
the underground water storage system comprises a water reservoir and a rainwater collection system, and is configured to collect and store rainwater to thereby reduce waste of water resources and provide supplementary water sources for irrigation; and
the water and fertilizer optimization and regulation model is configured to combine the crop growth cycle and changes in soil fertility.

4. A method of integrated water and fertilizer planting and industrial collaboration for a terraced field in an ecologically fragile area, comprising:
step a, arranging a terraced field irrigation equipment, soil moisture sensors, a meteorological station, fertilizer application devices, an underground water storage system, and a solar power supply in the terraced field in the ecologically fragile area, and monitoring humidity, temperature, and climatic conditions of the terraced field in real time;
step b, dynamically analyzing, based on data collected by the soil moisture sensors and the meteorological station, variables of soil moisture, temperature, precipitation and a wind speed in each of regions of the terraced field, and generating optimized water and fertilizer management methods for the respective regions of the terraced field through a data management platform;
step c, using a water balance and osmosis model to optimize scheduling of water resources, thereby preventing soil erosion and achieving an efficient utilization of water resources;
step d, adjusting irrigation methods in consideration of slopes, soil structures, and vegetation characteristics of the regions of the terraced field to ensure an optimal allocation of water resources;
step e, using a water and fertilizer optimization and adjustment model to determine application amounts of nitrogen fertilizer, potassium fertilizer and phosphorus fertilizer, and dynamically adjusting supplies of water and fertilizer according to factors including the soil moisture, the precipitation, the temperature, the humidity, crop growth cycles, and areas of the respective regions;
step f, dynamically monitoring a nutrient content and a pH value of soil, and optimizing, in combination with the crop growth cycles, fertilization methods to prevent nutrient loss and improve soil quality;
step g, inputting real-time data of supplies of water and fertilizer and crop growth requirements into an control algorithm to automatically adjust the irrigation methods and application amounts of fertilizers, ensuring efficient resource utilization;
step h, monitoring environmental conditions in real time through the meteorological station and adjusting system operating parameters, to avoid unnecessary waste of water and fertilizer;
step i, using an underground water storage system to collect and store rainwater for irrigation, thereby minimizing waste of water resources and improving water resource utilization of the terraced field;
step j, using an industrial collaboration model to optimize a regional industrial layout and thereby enhance an overall economic benefit, and dynamically optimizing industries including agriculture and forestry according to soil and water resources of the respective regions in the terraced field;
step k, analyzing input-output ratios of the respective regions, and automatically planning optimal crop planting types and areas to achieve ecological and industrial collocation in the respective regions of the terraced field; and
step l, generating a report through an economic benefit analysis module to assess efficiency of water resource utilization, improvement of soil quality, and a change of crop yield, and making, in combination with ecological protection and industrial benefits, dynamic adjustments on supplies of water and fertilizer.

5. The method as claimed in claim 4, wherein the application amount of nitrogen fertilizer is dynamically adjusted according to the soil moisture and the precipitation, in combination with the crop growth requirements, to thereby prevent loss or insufficient supply of nitrogen fertilizer.

6. The method as claimed in claim 4, wherein the control algorithm optimizes water and fertilizer management of the terraced field through machine learning, and dynamically adjust the supplies of water and fertilizer based on historical data, meteorological forecasts, and the crop growth cycles.

7. The method as claimed in claim 4, wherein the industrial collaboration model analyzes ecological conditions, crop planting types, and water resource utilization in the respective regions of the terraced field and optimizes a regional industrial planning, thereby achieving a coordinated development of agriculture, forestry, and animal husbandry.

8. The method as claimed in claim 4, wherein the economic benefit analysis module compares crop yields and the input-output ratios of the respective regions of the terraced field to generate an optimized industrial layout, and evaluates utilization efficiency of the water resources and the fertilizers.
